(19) United States
(12) Patent Application Publication
(10) Pub. No.: US 2024/0232817 A9
(43) Pub. Date: Jul. 11, 2024

(54) MAINTENANCE READINESS CHECK IN CLOUD ENVIRONMENT

(71) Applicant: SAP SE, Walldorf (DE)

(72) Inventor: Peter Schreiber, Wiesloch (DE)

(21) Appl. No.: 18/049,127

(22) Filed: Oct. 24, 2022

(51) Int. Cl. G06Q 10/00

(52) U.S. Cl. CPC G06Q 10/20

(57) ABSTRACT

Computer-readable media, methods, and systems are disclosed for determining maintenance readiness of at least one system in a cloud environment including requesting performance of a maintenance event by a user via a user interface and analyzing data from the at least one system to determine a readiness for the performance of the maintenance event. Analyzing the data may comprise predicting an expected downtime for the maintenance event for the at least one system, determining an effort estimation variable for the at least one system, and determining a maintenance readiness rating (MRR) for the at least one system based on the effort estimation variable and the expected downtime.

### TECHNICAL FIELD

Embodiments generally relate to a maintenance check system, and more particularly a system and method for determining maintenance readiness in a cloud data center environment.

The challenges for all maintenance events, such as patching, update, and upgrade, are the individual characteristics of the systems. Such characteristics may include component vector, release, database (DB), kernel, modifications, self-developments, and customizing. Thus, every maintenance event is unique, and must be administered by experienced employees. Even so, the chance for failure of the maintenance procedure is high. Furthermore, there is currently no way to estimate necessary efforts for data center operations users and to predict the downtime window, such as with respect to the service-level agreement (SLA). Maintenance in the private cloud environment is currently a trial-and-error procedure with many failures and unexpected behavior in regards to effort and downtime.

### SUMMARY

Disclosed embodiments address the above-mentioned problems by providing one or more non-transitory computer-readable media storing computer-executable instructions that, when executed by at least one processor, perform a method for determining maintenance readiness of at least one system in a cloud environment, the method including: requesting performance of a maintenance event by a user via a user interface; analyzing data from the at least one system to determine a readiness for the performance of the maintenance event; wherein analyzing the data includes: predicting an expected downtime for the maintenance event for the at least one system; and determining an effort estimation variable for the at least one system; and determining a maintenance readiness rating (MRR) for the at least one system based on the effort estimation variable and the expected downtime.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1A illustrates a service provider cockpit (SPC) application flow.

FIG. 1B illustrates a method for processing data.

FIG. 2 shows an embodiment of a system including a cloud environment, a maintenance readiness check service, and an analytics unit.

FIG. 3 illustrates a component diagram of an exemplary system.

FIG. 4 shows an exemplary MRC document.

FIG. 5 shows an embodiment of a process for upgrading a system.

FIG. 6 provides an exemplary flowchart for a system upgrade.

FIG. 7 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

There are generally two types of cloud services: private and public. Private cloud services provide individual component structure, and allow modifications, customer development, and third-party add-ons. In a private cloud, the kernel and database (DB) level and the update/upgrade cycles are individualized. In a public cloud, there are standardized components, fewer possible modifications, only predefined enhancements, and no additional components. In a public cloud, the upgrade/update cycles are the same across the entire system and landscape.

Maintenance of systems in a private cloud is much more costly compared to public cloud implementations. In typical public cloud implementations, maintenance events are highly automated and readily broadly deployed. Upgrades to the public cloud may routinely be performed on weekends when usage is low, and all systems may be patched with few administrators and a very small number of incidents. Automation is based on the usage of a statistical process control (SPC), where the steps and dialogues can be predefined due to the nature of the common components, release, and patch level of the systems. Furthermore, organizations invest a lot in the public cloud to decrease downtime and ensure Zero Impact (such as BlueGreen (SOI, VZDO), MultiTenancy, etc.).

In an embodiment, a goal is smoothing and automating maintenance events such as applying notes, patches (kernel, DB . . . ), updates and upgrades, and conversions. Data collected in order to achieve this goal may include database sizes, the number of modifications, dictionary consistency, the number of third-party add-ons, etc. A software system as described herein may be modified/customized by a user. The more modifications that are made, the harder it is to perform a maintenance event, such as an upgrade.

Embodiments described herein are intended to modify private cloud maintenance to be more similar to public cloud maintenance. This can be accomplished by checking for readiness of private cloud systems for a potential move to the public cloud, thereby giving guidance to users to avoid pitfalls that might lead later to problems in the maintenance, or which prevent a move to the public cloud. Additionally, one may proactively improve systems for a smoother maintenance, e.g., by housekeeping projects etc.

Embodiments are described herein to collect data from public cloud systems and classify the systems at least in regards to downtime and effort estimation. Using a downtime prediction tool, the expected downtime for a maintenance event can be calculated for all systems. Furthermore, an effort estimation variable can also be determined for every system. Using these two parameters, a standardized maintenance readiness rating can be determined for every system.

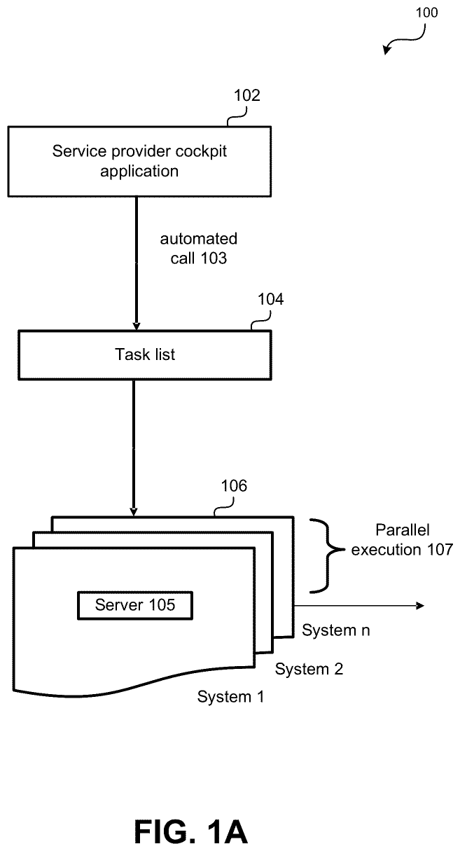

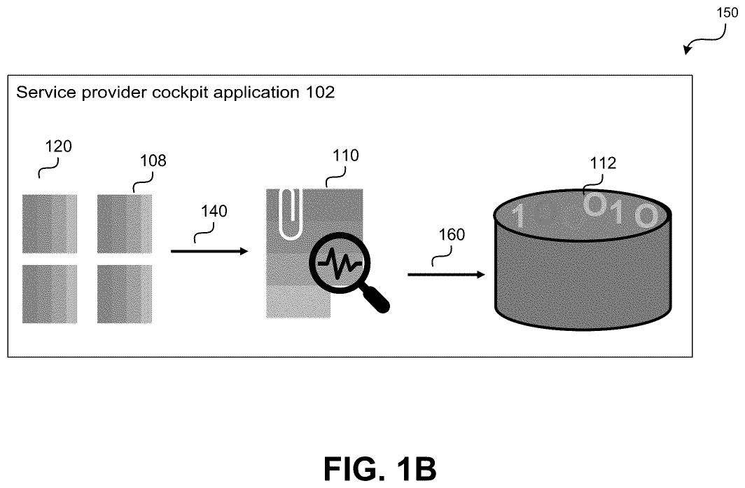

FIG. 1A illustrates a service provider cockpit (SPC) flow. A service provider cockpit application 102 is provided. A service provider cockpit application 102 may be a central web-based user interface to enable users, such as administrators, to manage applications. In an embodiment, service provider cockpit application 102 sends an automated call 103 to a task list 104. Then task list 104 sends a request to a server 105, which may be located on a system 106. In an embodiment, task list 104 may send multiple requests to multiple servers located on multiple systems, such as system 1, system 2, system n, such as in a parallel execution 107. In some embodiments, the requests may be sent sequentially.

As seen in FIG. 1B, the service provider cockpit application 102 may process data according to method 150. The data received is then processed into chunks of data 108 at step 120. At step 140, the data may then be used to prepare file attachments 110, such as in XML or JSON format. At step 160, the data may be sent to a data lake 112, such as a cloud lifecycle management (CLM) data lake. A data lake is a central data repository that stores vast amounts of raw data in its native format, which may be structured, unstructured, or semi-structured. A data lake helps to address data silo issues, is easily scalable, and can be used with applied machine learning analytics.

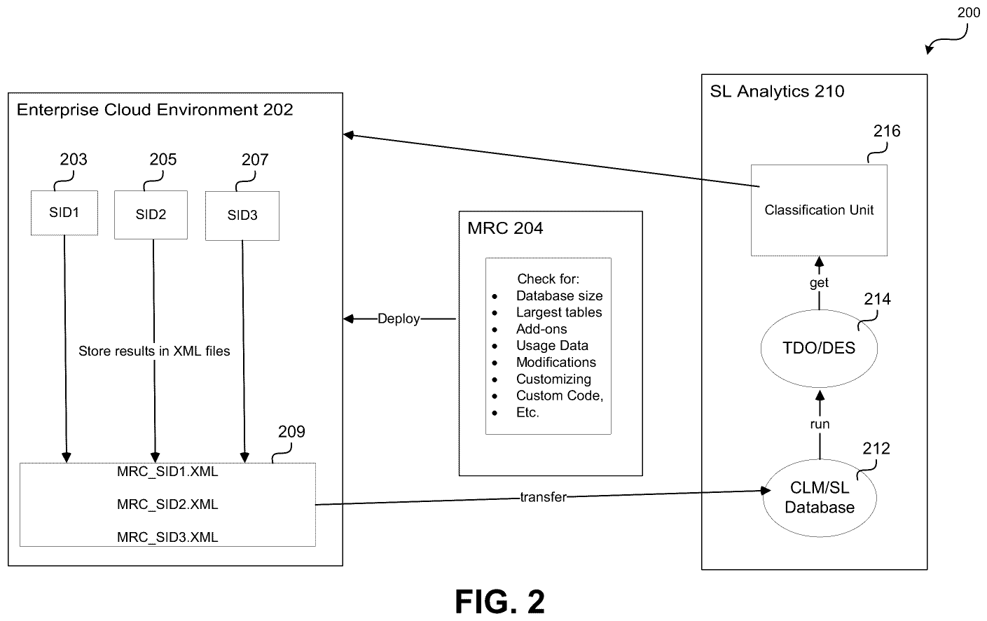

FIG. 2 shows system 200 including a private managed cloud environment 202, such as HANA Enterprise Cloud (HEC), maintenance readiness check (MRC) service 204, and software logistics (SL) analytics unit 210. In one embodiment, the system regularly retrieves data relevant for maintenance events, such as by weekly calls to a hosted system in a private cloud environment. Cloud environment 202 may include multiple systems 203, 205, 207 each having a system identification (SID). Each system 203, 205, 207 sends data to store results, such as in XML files in database 209. The data can then be transferred to a database 212, such as cloud lifecycle management (CLM)/software logistics (SL) database. Database 212 sends a call to run a technical downtime optimization application (TDO)/downtime estimation service (DES) 214. TDO/DES 214 determines a downtime estimation, as described in co-owned U.S. Pat. No. 11,301,353, which is herein incorporated by reference in its entirety. TDO/DES 214 then sends a call to get data from classification unit 216. Classification unit 216 then sends the data to enterprise cloud environment 202.

System 200 must determine what data to collect in the private cloud environment 202. A maintenance readiness check (MRC) service 204 may deploy checks in all hosted systems 203, 205, 207, such as by a transport-based correction instruction (TCI). A master report can be prepared, calling N Classes to retrieve data and perform checks. Checks may be performed to retrieve multiple variables, for example, component vectors; number and nature of modifications; number and nature of customer development; number of clients; languages; database (DB) size; 100 largest tables; namespaces; usage data; and infrastructure metrics. Additionally, many customizing specific checks may be performed, which may already defined and be enhanced.

Data collectors consistent with the present teachings may run regularly as a batch job, health check, and/or task list, such once a week. Results are stored in the file system/database 209, such as in a file like MRC_SID.XML. The service provider cockpit (SPC) application 102 regularly collects those results and can display them to a user on a user interface. Cloud lifecycle management (CLM)/software logistics (SL) analytics unit 210 consumes the results and runs analytics, as will be described herein.

A method described with respect to system 200 may include collecting data with a lightweighted check, provided as a note, or part of an SL analytics 210 add-on or as a transport based correction instruction (TCI). In an embodiment, this may be performed according to a defined schedule, such as once a week, biweekly, or monthly. The data may be stored in a XML file locally on each system (MAINTENANCE.XML). The XML files may be collected with a SPC procedure. The XML files may be stored in the CLM/SL database 212. The data may be sent to TDO/DES application 214 to return a downtime estimation for all systems. Classification unit 216 analyzes and classifies the systems, such as systems 205, 207, 209, in regards to downtime and effort estimation.

Analyzing the data may include an effort estimation to determine an effort estimation variable. A scale for this effort estimation is established based on at least the following influencing factors: number of modifications, add-ons, usage of the system, and size of specific tables (e.g., for finance (FIN) migration). The result would be a parameter to estimate the amount of effort that a user in operations must spend and the interactions with a user/customer for a maintenance event.

As a first consequence of the effort and downtime estimation, a maintenance readiness rating (MRR) can be assigned to every system and/or group of systems. For example, if 50% of the systems have a database size of <500 GB, no (or very little) modifications, and no negative listed add-ons, etc., then this would result in a very low MRR. A high MRR (90%-100%) means there is a low effort for the maintenance event, the downtime agreement will be satisfied, and there is likely a positive outcome for automation and mass readiness. Conversely, a low MRR (such as 10%-20%) may mean that there is a high effort required for the maintenance event, and a special procedure may be needed, such as zero downtime option (ZDO), near zero downtime technology (NZDT) Downtime optimized conversion (DoC) in order to satisfy the downtime agreement. The MRR may be displayed to a user in a user interface, such as by a percentage, a ranking, a color-code, or any other easily readable format to indicate the level of ease and expected success with which the maintenance event can be performed or not.

Once a user has been provided with the MRR, they can proactively work on improving the MRR to make it easier to perform a maintenance event in the future. Some examples of ways to improve are performing housekeeping efforts, such as archiving and storing historical data, reducing the number of modifications and user/customer development, and clarifying the upgrade strategy for 3^{rd} party add-ons (zero downtime option (ZDO) enablement, etc.)

By extending the framework with usage data, it is possible to ease other maintenance processes, such as applying security notes. For example, if a security note corrects a particular application, and this application is not used in many of the systems, this note may be applied without any user communication and without the need for regression testing. Also, in order to make maintenance easier, custom developments may be removed and add-ons may be uninstalled if no longer needed.

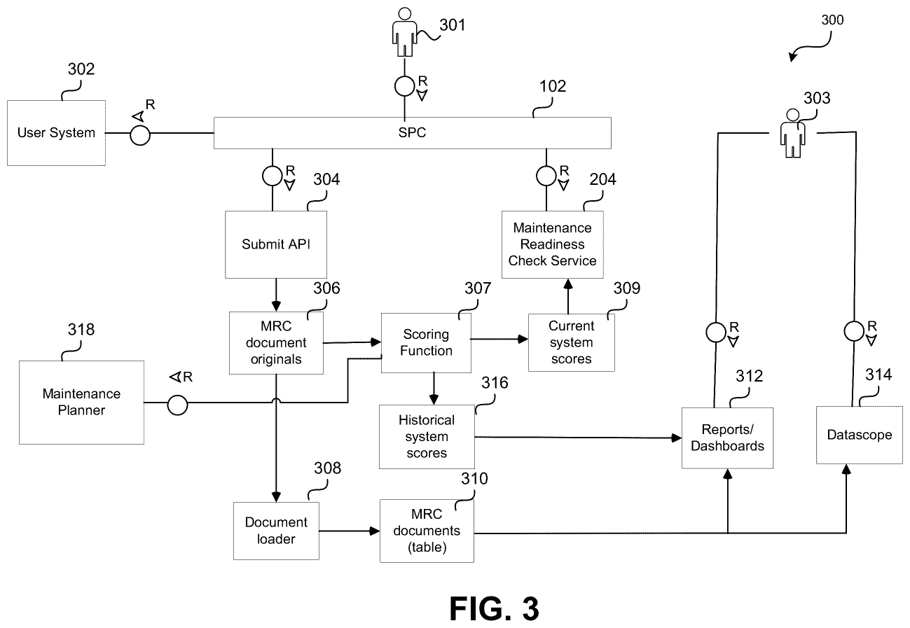

FIG. 3 illustrates a component diagram of an exemplary system 300. User 301 submits a request via a user interface of service provider cockpit application 102 and evaluates the system groups. Service provider cockpit application 102 pulls check results (RFC) from user system 302. Service provider cockpit application 102 also sends a request to submit an API at step 304, which requests MRC document originals 306. MRC document originals 306 are sent to document loader 308 and to scoring function 307. Document loader 308 compiles MRC documents 310, such as into a table, and sends to data reports/dashboards 312 and to datascope 314 (representing the full coverage of the data). A user 303 may request the reports/dashboards 312 and/or information from datascope 314. Scoring function 307 also sends data to current system scores at 309, to historical system scores at 316, and to maintenance readiness check service 204. Scoring function 307 may also send a query to maintenance planner 318 to add-on database.

With respect to FIG. 3, a user 301 can request data from maintenance readiness check service 204 via a user interface of the service provider cockpit application 102. Thus, ingestion functions may be performed at elements 304, 306, 308 and 307. Data may be stored in reports/dashboards 312, current system scores 309, and historical system scores 316. Reporting may be performed by components of 316, 312 and 314.

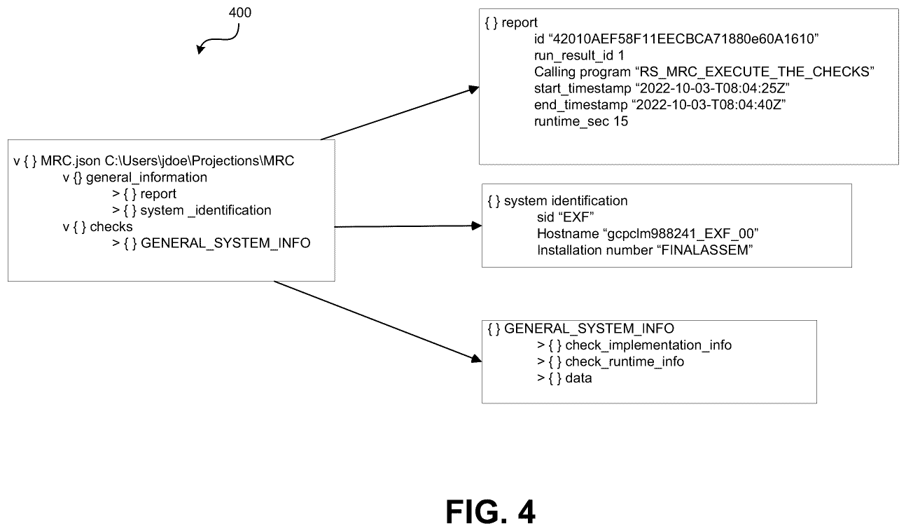

With respect to FIG. 4, an exemplary MRC document 400 is shown. The document may be in JSON format. Additionally, in an embodiment, the document may have a schema enforced, such as in a schema-restricted JSON format (metadata), which may be schema-less in the data part. Thus the data can carry any information that may be useful. Since the data attribute is schema-less, it may have new attributes, a deep tree, and a timestamp, such as in a RFC 3339 format. It should avoid content-dependent key names, renaming of existing attributes, changing type of existing attributes, non-conformant timestamps (such as missing timezone, non-RFC 3393 format), typing numbers as strings, and typing strings as numbers.

In an embodiment, the maintenance event to be performed by the system may be, for example, a kernel patch and upgrade, a support package update, and/or a release upgrade. Criteria for a kernel patch and upgrade may include: if the golden standard is met, the number of server (e.g., application server) and instances and homogeneous/heterogeneous, and release notes for the kernel patch. In an embodiment, if the maintenance event is a support package update or a release upgrade, the criteria may include: how big the change is from the prior version, number of modifications, number of notes, and number of user/customer objects. In an embodiment, if the maintenance event is a release upgrade, additional criteria may include: add-ons (especially for a 3rd party), dependencies of the new content to a particular database version, and nature of the system (test, development, quality and production), and dependencies in the landscape.

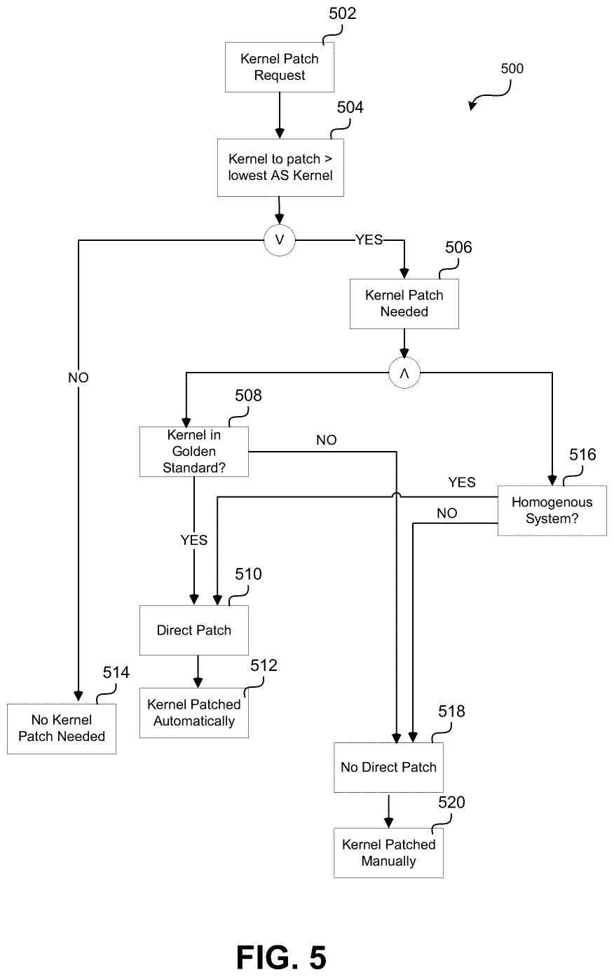

With respect to FIG. 5, in one embodiment, a system is to be upgraded (such as by a kernel patch) by a process 500. In step 502, a kernel patch request is submitted. At step 504, it is determined if the kernel to patch>lowest application server (AS) kernel. If no, the process proceeds to step 514 and no patch is needed. If yes, the process proceeds to step 506 to further determine if a kernel patch is needed. Two elements are considered—is the kernel version in the golden standard (such as the most stable or current release) at step 508 and is the system homogeneous at step 516. It is determined if the kernel version+patch level (PL) is newer than the currently installed kernel. It is also determined if the installed kernel version is in the golden standard, such as by a 3^{rd} party definition. If the kernel is in the golden standard and the system is homogeneous, the process can proceed to 510 for a direct patch and the kernel can be patched automatically at step 512 without risk. If the kernel is not in the golden standard and the system is not homogenous, a direct patch is not recommended at 518, as automatic patching will cause risk. In this case, kernel can be patched manually at step 520. These rules can be implemented by scoring function 307 in cooperation with the maintenance readiness check service 204, as shown in FIG. 3. Scoring function 307 can deliver patching information that is consumable by various web services.

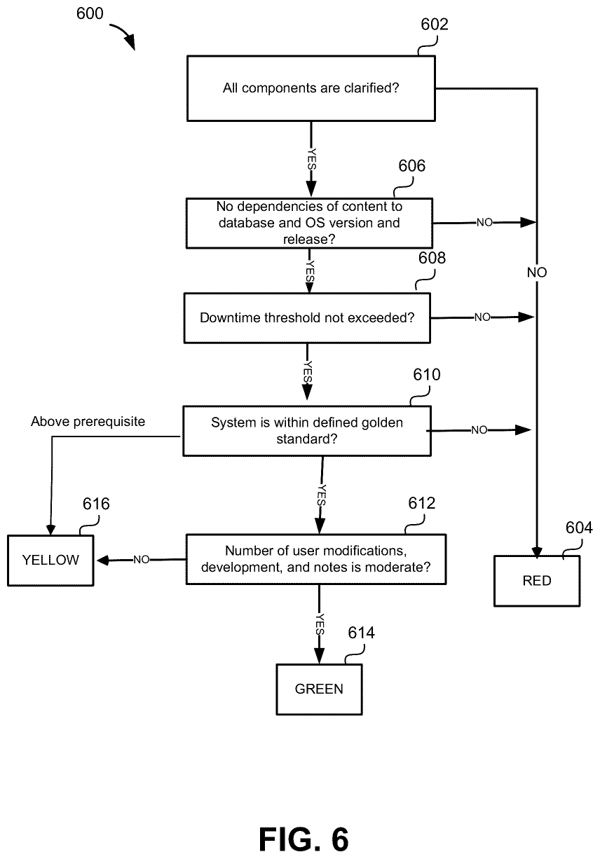

FIG. 6 provides an exemplary flowchart 600 for a system upgrade. At step 602, the upgrade database is asked if all components are clarified in regard to upgrade strategy. This is especially important with respect to 3rd party add-ons. If no, the process returns a negative result, such as indicated by “RED” at 604. If yes, the process continues to step 606. At step 606, the system asks if there are any dependencies. If there are dependencies of content to database and OS version and release, the process returns a negative result, such as indicated by “RED” at 604. If there are no dependencies, the process continues to step 608. At step 608, the system determines an expected downtime and compares this to a downtime threshold (such as in an SLA) to determine if this is below an allowed threshold. If the downtime threshold will be exceeded, the process returns a negative result, such as indicated by “RED” at 604. If the downtime threshold will not be exceeded, the process proceeds to step 610. At step 610, the system determines if the system is within a defined golden standard. If yes, the process proceeds to step 612. If a minimum prerequisite for the upgrade is fulfilled, the process stores an intermediate result, such as indicated by “YELLOW” and still continues to step 612. If the minimum prerequisite is not fulfilled, the process returns a negative result, such as indicated by “RED” at 604. The database PL N is the golden standard. PL N-M is the minimum required for the upgrade to occur. In an embodiment, the golden standard is a scale defined by the architect of each particular product.

At step 612, the process determines if the number of user modifications, development, and notes is moderate. If the modifications are determined to be moderate, such as determined by the golden standard, the process returns a positive result, such as indicated by “GREEN” at 614. If the modifications are determined to be more than moderate, the process returns an intermediate result, such as indicated by “YELLOW” at 616. If any “RED” result is returned for any of the steps, then no upgrade is possible. If one or more “YELLOW” results are returned, then the upgrade may be possible but with a high effort. If a “GREEN” result is returned for all variables, then the upgrade is possible with a low effort.

In an embodiment, a positive, negative or intermediate result may be returned and stored for each of the five parameters defined by steps 602, 606, 608, 610 and 612. Thus, a result may be: RED, RED, RED, YELLOW, YELLOW. In this case, no upgrade would be possible. This result may be correlated to a maintenance readiness rating (MRR), such as 40%. In an example, for a system that has a huge database, many modifications, and many additional components, it would be hard to perform maintenance and thus the system would have a low MRR. In another embodiment, a result may be: GREEN, GREEN, GREEN, GREEN, GREEN. In this case, an upgrade would be possible with low effort and a MRR may be 100%. For example, a system that has a small database size, no modifications, and no additional components, this system would be determined to be relatively easy to maintain and have a high MRR.

In one embodiment, the results can be that the patch is deployable with or without customer communication. In another embodiment, the upgrade may be deployable without the need for test runs. In one embodiment, the upgrade strategy must be changed in order to meet a downtime threshold (such as detailed in a user agreement or SLA). In one embodiment, grouping of similar systems for mass automation might be applicable.

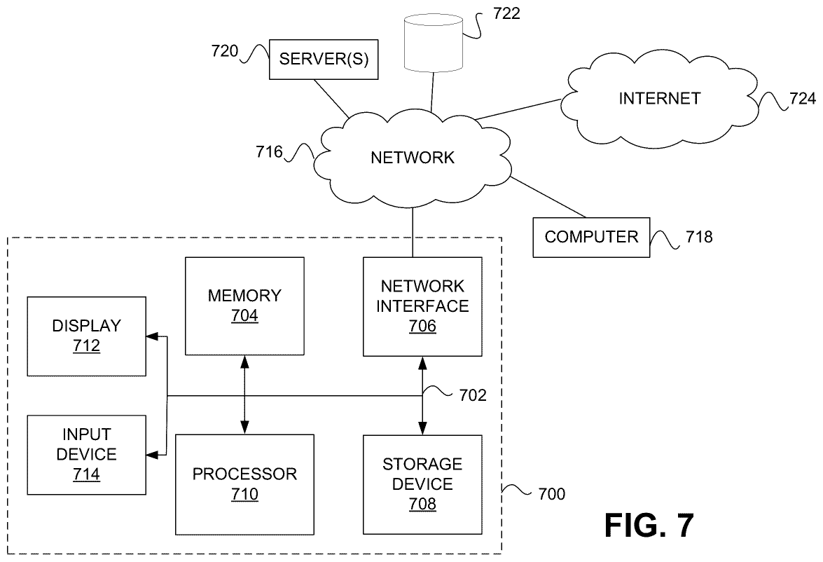

FIG. 7 is a diagram illustrating a sample computing device architecture for implementing various aspects described herein. Computer 700 can be a desktop computer, a laptop computer, a server computer, a mobile device such as a smartphone or tablet, or any other form factor of general- or special-purpose computing device containing at least one processor. Depicted with computer 700 are several components, for illustrative purposes. Certain components may be arranged differently or be absent. Additional components may also be present. Included in computer 700 is system bus 702, via which other components of computer 700 can communicate with each other. In certain embodiments, there may be multiple busses or components may communicate with each other directly. Connected to system bus 702 is processor 710. Also attached to system bus 702 is memory 704. Also attached to system bus 702 is display 712. In some embodiments, a graphics card providing an input to display 712 may not be a physically separate card, but rather may be integrated into a motherboard or processor 710. The graphics card may have a separate graphics-processing unit (GPU), which can be used for graphics processing or for general purpose computing (GPGPU). The graphics card may contain GPU memory. In some embodiments no display is present, while in others it is integrated into computer 700. Similarly, peripherals such as input device 714 is connected to system bus 702. Like display 712, these peripherals may be integrated into computer 700 or absent. Also connected to system bus 702 is storage device 708, which may be any form of computer-readable media, such as non-transitory computer readable media, and may be internally installed in computer 700 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 706 is also attached to system bus 702 and allows computer 700 to communicate over a network such as network 716. Network interface 706 can be any form of network interface known in the art, such as Ethernet, ATM, fiber, Bluetooth, or Wi-Fi (i.e., the Institute of Electrical and Electronics Engineers (IEEE) 802.11 family of standards). Network interface 706 connects computer 700 to network 716, which may also include one or more other computers, such as computer 718, and network storage 722, such as cloud network storage. Network 716 is in turn connected to public Internet 724, which connects many networks globally. In some embodiments, computer 700 can itself be directly connected to public Internet 724.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects in sufficient detail to enable those skilled in the art to practice the embodiments. Other embodiments can be utilized, and changes can be made without departing from the claimed scope. The following detailed description is, therefore, not to be taken in a limiting sense. The scope of embodiments is defined only by the appended claims, along with the full scope of equivalents to which such claims are entitled.

Having thus described various embodiments, what is claimed as new and desired to be protected by Letters Patent includes the following:

1. One or more non-transitory computer-readable media storing computer-executable instructions that, when executed by at least one processor, perform a method for determining maintenance readiness of at least one system in a cloud environment, the method comprising:
requesting performance of a maintenance event by a user via a user interface;
analyzing data from the at least one system to determine a readiness for the performance of the maintenance event;
wherein analyzing the data comprises:
determining an effort estimation variable for the at least one system; and
predicting an expected downtime for the maintenance event for the at least one system; and
determining a maintenance readiness rating (MRR) for the at least one system based on the effort estimation variable and the expected downtime.

2. The non-transitory computer-readable media of claim 1, wherein the maintenance event to be performed by the system comprises at least one of: a kernel patch or upgrade, a support package update, and a release upgrade.

3. The non-transitory computer-readable media of claim 1, wherein determining the effort estimation variable comprises:
analyzing a plurality of factors for the at least one system, said plurality of factors including a golden standard prerequisite, a number of system dependencies, a number and nature of user modifications, and a clarification of components for the at least one system.

4. The non-transitory computer-readable media of claim 3, wherein the method further comprises:
determining a negative result, a positive result, or an intermediate result for each of the plurality of factors,
wherein a positive result indicates a low effort is required for performing the maintenance event.

5. The non-transitory computer-readable media of claim 4, wherein determining the MRR further comprises:
comparing the expected downtime to a downtime threshold.

6. The non-transitory computer-readable media of claim 5, wherein the method further comprises:
providing a high MRR rating to the user via the user interface based on a positive result for all of the plurality of factors and the expected downtime being below the downtime threshold, said high MRR rating indicating that the maintenance event should be performed.

7. The non-transitory computer-readable media of claim 6, wherein the method further comprises:
providing a low MRR rating to the user via the user interface based on a negative result for any of the plurality of factors or the expected downtime being above the downtime threshold, said low MRR rating indicating that the maintenance event should not be performed.

8. A method for determining maintenance readiness of at least one system in a cloud environment, the method comprising:
requesting performance of a maintenance event by a user via a user interface;
analyzing data from the at least one system to determine a readiness for the performance of the maintenance event;
wherein analyzing the data comprises:
determining an effort estimation variable for the at least one system; and
predicting an expected downtime for the maintenance event for the at least one system; and
determining a maintenance readiness rating (MRR) for the at least one system based on the effort estimation variable and the expected downtime.

9. The method of claim 8, wherein the maintenance event to be performed by the system comprises at least one of: a kernel patch or upgrade, a support package update, and a release upgrade.

10. The method of claim 8, wherein determining the effort estimation variable comprises:
analyzing a plurality of factors for the at least one system, said plurality of factors including a golden standard prerequisite, a number of system dependencies, a number and nature of user modifications, and a clarification of components for the at least one system.

11. The method of claim 10, further comprising:
determining a negative result, a positive result, or an intermediate result for each of the plurality of factors,
wherein a positive result indicates a low effort is required for performing the maintenance event.

12. The method of claim 11, wherein determining the MRR further comprises:
comparing the expected downtime to a downtime threshold.

13. The method of claim 12, further comprising:
providing a high MRR rating to the user via the user interface based on a positive result for all of the plurality of factors and the expected downtime being below the downtime threshold, said high MRR rating indicating that the maintenance event should be performed.

14. The method of claim 13, further comprising:
providing a low MRR rating to the user via the user interface based on a negative result for any of the plurality of factors or the expected downtime being above the downtime threshold, said low MRR rating indicating that the maintenance event should not be performed.

15. A system for determining maintenance readiness of at least one system in a cloud environment, the system comprising:
at least one processor;
and at least one non-transitory memory storing computer executable instructions that when executed by the at least one processor cause the system to carry out actions comprising:
requesting performance of a maintenance event by a user via a user interface;
analyzing data from the at least one system to determine a readiness for the performance of the maintenance event;
wherein analyzing the data comprises:
determining an effort estimation variable for the at least one system; and
predicting an expected downtime for the maintenance event for the at least one system; and
determining a maintenance readiness rating (MRR) for the at least one system based on the effort estimation variable and the expected downtime.

16. The system of claim 15, wherein the maintenance event to be performed by the system comprises at least one of: a kernel patch or upgrade, a support package update, and a release upgrade.

17. The system of claim 15, wherein determining the effort estimation variable comprises:
analyzing a plurality of factors for the at least one system, said plurality of factors including a golden standard prerequisite, a number of system dependencies, a number and nature of user modifications, and a clarification of components for the at least one system.

18. The system of claim 17, wherein the actions further comprise:
determining a negative result, a positive result, or an intermediate result for each of the plurality of factors,
wherein a positive result indicates a low effort is required for performing the maintenance event.

19. The system of claim 18, wherein determining the MRR further comprises:
comparing the expected downtime to a downtime threshold.

20. The system of claim 19, wherein the actions further comprise:
providing a high MRR rating to the user via the user interface based on a positive result for all of the plurality of factors and the expected downtime being below the downtime threshold, said high MRR rating indicating that the maintenance event should be performed; and
providing a low MRR rating to the user via the user interface based on a negative result for any of the plurality of factors or the expected downtime being above the downtime threshold, said low MRR rating indicating that the maintenance event should not be performed.
